(19) United States
(12) Patent Application Publication
(10) Pub. No.: US 2003/0204548 A1
(43) Pub. Date: Oct. 30, 2003

(54) Method and apparatus for batching commands in a small computer system interface system

(76) Inventors: Guy Wayne Kendall, Colorado Springs, CO (US); Stephen Bach Johnson, Colorado Springs, CO (US); Christopher John McCarty, Colorado Springs, CO (US); Bradley Dean Besmer, Colorado Springs, CO (US)

Correspondence Address: LSI Logic Corporation, Intellectual Property Services Group, M/S D-106, 1551 McCarthy Boulevard, Milpitas, CA, 95035, US

(21) Appl. No.: 10/133,763

(22) Filed: Apr. 26, 2002

(51) Int. Cl. G06F 13/10

(52) U.S. Cl. 709/101; 709/321

(57) ABSTRACT

A method, apparatus, and processor instructions for processing commands in a small computer system interface controller. A current command is received from a host in which the current command is associated with a first target identifier. A determination is made as to whether a subsequent command is available after the current command. A determination is also made as to whether the first target identifier matches a second target identifier and is associated with the subsequent command. The current command is batched with the subsequent command if the first target identifier matches the second target identifier in which case the current command and the subsequent command are sent using a single connection. The comparing of target IDs and combining of commands continue until no further messages are available or until a match between target identifiers is absent. At that time, the batched messages are sent to the target.

### BACKGROUND OF THE INVENTION

1. Technical Field

The present invention is directed generally toward a method and apparatus for processing data, and in particular, to a method and apparatus for handling messages in a small computer system interface (SCSI) system. Still more particularly, the present invention provides a method and apparatus for batching commands in a SCSI system.

2. Description of the Related Art

SCSI is a hardware interface system that allows for the connection of multiple devices to a single SCSI host adapter. This host adapter is typically connected to a motherboard in a computer through a peripheral component interconnect (PCI) slot. With this type of system, peripherals are daisy chained together. These peripherals have a second port used to connect the next device in line. This type of interface system is widely used, from desktop PCs to mainframe computers, and is widely used in redundant array of independent disks (RAID) configurations.

The protocols defining SCSI have evolved over time. In a SCSI parallel interface (SPI), SPI-4 is a standard that allows for multiple commands to be sent to a target if the initiator has more than one command ready to send to a specific target identifier and the packetized (information units) protocol has been negotiated with the target. Before SPI-4 was created, SCSI input/output requests were sent to targets one request at a time. The sending of each command required arbitration to obtain the bus, selection to select a target, and a disconnect to relinquish the bus. Having to perform the arbitration, selection, and disconnect procedures for every command is time consuming and reduces performance if many commands are sent to the same target. “Multiple Command” is the SCSI method that allows for multiple commands to be sent to the target in SPI-4 when packetized protocol has been negotiated with the target. This specification, however, does not specify how the initiator, which is the controller, batches commands to create a “Multiple Command” stream.

Therefore, it would be advantageous to have an improved method, apparatus, and processor instructions for batching incoming input/output requests from a host into a ”Multiple Command” stream.

### SUMMARY OF THE INVENTION

The present invention provides a method, apparatus, and processor instructions for processing commands in a small computer system interface controller. A current command is received from a host in which the current command is associated with a first target identifier. A determination is made as to whether a subsequent command is available after the current command. A determination is also made as to whether the first target identifier matches a second target identifier and is associated with the subsequent command. The current command is batched with the subsequent command if the first target identifier matches the second target identifier in which the current command and the subsequent command are sent using a single connection. The comparing of target IDs and combining of commands continue until no further messages are available or until a match between target identifiers is absent. At that time, the batched messages are sent to the target.

### BRIEF DESCRIPTION OF THE DRAWINGS

The novel features believed characteristic of the invention are set forth in the appended claims. The invention itself however, as well as a preferred mode of use, further objects and advantages thereof, will best be understood by reference to the following detailed description of an illustrative embodiment when read in conjunction with the accompanying drawings, wherein:

FIG. 1 is a pictorial representation of a data processing system in which the present invention may be implemented in accordance with a preferred embodiment of the present invention;

FIG. 2 is a block diagram of a data processing system in which the present invention may be implemented;

FIG. 3 is a diagram illustrating components used in sending input/output requests to a target device;

FIG. 4 is a diagram of a SCSI controller in accordance with a preferred embodiment of the present invention; and

FIG. 5 is a flowchart illustrating a process for batching commands in accordance with a preferred embodiment of the present invention.

### DETAILED DESCRIPTION

With reference now to the figures and in particular with reference to FIG. 1, a pictorial representation of a data processing system in which the present invention may be implemented is depicted in accordance with a preferred embodiment of the present invention. A computer 100 is depicted which includes system unit 102, video display terminal 104, keyboard 106, storage devices 108, which may include floppy drives and other types of permanent and removable storage media, and mouse 110. Additional input devices may be included with personal computer 100, such as, for example, a joystick, touchpad, touch screen, trackball, microphone, and the like. Computer 100 can be implemented using any suitable computer, such as an IBM RS/6000 computer or IntelliStation computer, which are products of International Business Machines Corporation, located in Armonk, N.Y. Although the depicted representation shows a computer, other embodiments of the present invention may be implemented in other types of data processing systems, such as a network computer. Computer 100 also preferably includes a graphical user interface (GUI) that may be implemented by means of systems software residing in computer readable media in operation within computer 100.

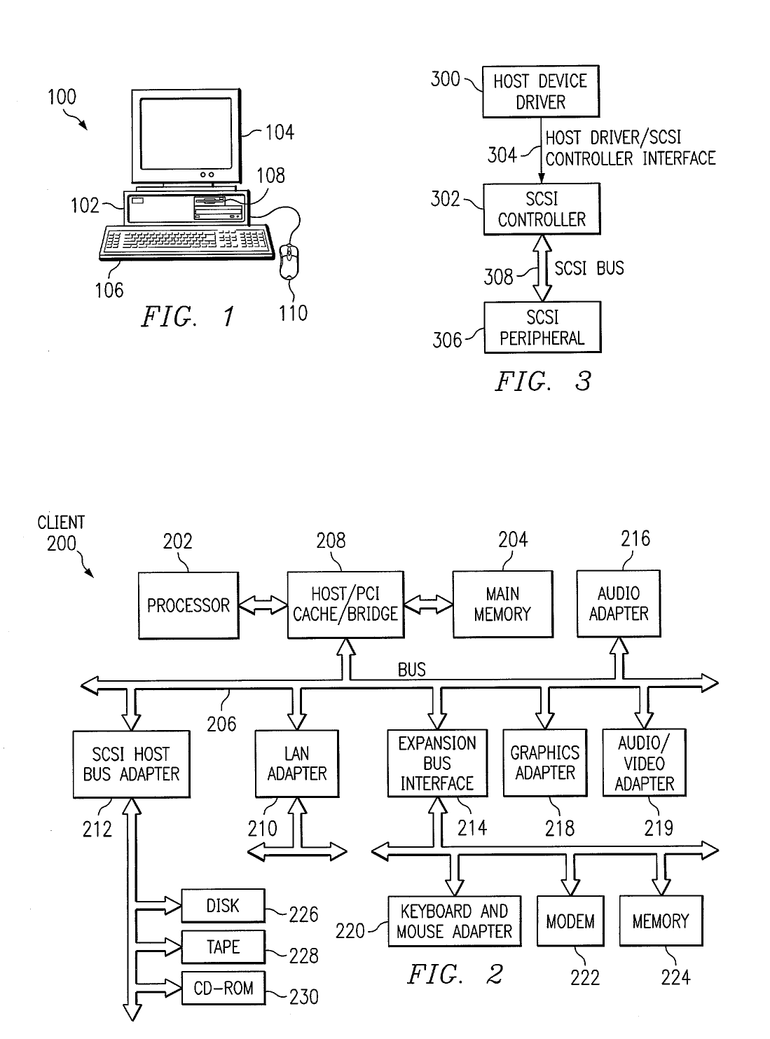

With reference now to FIG. 2, a block diagram of a data processing system is shown in which the present invention may be implemented. Data processing system 200 is an example of a computer, such as computer 100 in FIG. 1, in which code or instructions implementing the processes of the present invention may be located. Data processing system 200 employs a peripheral component interconnect (PCI) local bus architecture. Although the depicted example employs a PCI bus, other bus architectures such as Accelerated Graphics Port (AGP) and Industry Standard Architecture (ISA) may be used. Processor 202 and main memory 204 are connected to PCI local bus 206 through PCI bridge 208. PCI bridge 208 also may include an integrated memory controller and cache memory for processor 202. Additional connections to PCI local bus 206 may be made through direct component interconnection or through add-in boards. In the depicted example, local area network (LAN) adapter 210, small computer system interface SCSI host bus adapter 212, and expansion bus interface 214 are connected to PCI local bus 206 by direct component connection. In contrast, audio adapter 216, graphics adapter 218, and audio/video adapter 219 are connected to PCI local bus 206 by add-in boards inserted into expansion slots. Expansion bus interface 214 provides a connection for a keyboard and mouse adapter 220, modem 222, and additional memory 224. SCSI host bus adapter 212 provides a connection for hard disk drive 226, tape drive 228, and CD-ROM drive 230. Typical PCI local bus implementations will support three or four PCI expansion slots or add-in connectors.

An operating system runs on processor 202 and is used to coordinate and provide control of various components within data processing system 200 in FIG. 2. The operating system may be a commercially available operating system such as Windows 2000, which is available from Microsoft Corporation. An object oriented programming system such as Java may run in conjunction with the operating system and provides calls to the operating system from Java programs or applications executing on data processing system 200. “Java” is a trademark of Sun Microsystems, Inc. Instructions for the operating system, the object-oriented programming system, and applications or programs are located on storage devices, such as hard disk drive 226, and may be loaded into main memory 204 for execution by processor 202.

Those of ordinary skill in the art will appreciate that the hardware in FIG. 2 may vary depending on the implementation. Other internal hardware or peripheral devices, such as flash read only memory (ROM) or equivalent nonvolatile memory, or optical disk drives and the like, may be used in addition to or in place of the hardware depicted in FIG. 2. Also, the processes of the present invention may be applied to a multiprocessor data processing system.

For example, data processing system 200, if optionally configured as a network computer, may not include SCSI host bus adapter 212, hard disk drive 226, tape drive 228, and CD-ROM 230. In that case, the computer, to be properly called a client computer, includes some type of network communication interface, such as LAN adapter 210, modem 222, or the like. As another example, data processing system 200 may be a stand-alone system configured to be bootable without relying on some type of network communication interface, whether or not data processing system 200 comprises some type of network communication interface. As a further example, data processing system 200 may be a personal digital assistant (PDA), which is configured with ROM and/or flash ROM to provide nonvolatile memory for storing operating system files and/or user-generated data.

The depicted example in FIG. 2 and above-described examples are not meant to imply architectural limitations. For example, data processing system 200 also may be a notebook computer or hand held computer in addition to taking the form of a PDA. Data processing system 200 also may be a kiosk or a Web appliance. The mechanism of the present invention is located on a processor or application specific integrated circuit (ASIC) inside a SCSI controller.

FIG. 3 is a diagram illustrating components used in sending input/output (I/O) requests to a target device. In this example, host device driver 300 is a device driver that may be running on an operating system or as part of a RAID controller. Host device driver 300 creates a message that contains a SCSI command that is to be sent to a SCSI peripheral. Host device driver 300 sends this message to SCSI controller 302 across host driver/SCSI controller interface 304. The message also may be referred to as an I/O request. In turn, SCSI controller 302 processes the message and initiates a SCSI sequence to send the command to SCSI peripheral 306 across SCSI bus 308. SCSI peripheral 306 is identified through a target ID that is contained in a message received from host device driver 300. SCSI controller 302 may be implemented within SCSI host bus adapter 212 in FIG. 2. SCSI peripheral 306 may be, for example, hard disk drive 226 or tape drive 228 in FIG. 2.

As illustrated, SCSI controller 302 is the initiator and SCSI peripheral 306 is the target. In sending commands to SCSI peripheral 306, SCSI controller 302 will perform arbitration to obtain control of SCSI bus 308. After control of SCSI bus 308 has been obtained, SCSI controller 302 will select SCSI peripheral 306 and send commands to SCSI peripheral 306 over SCSI bus 308. In these examples, the mechanism of the present invention allows for multiple commands to be batched and sent at the same time. After the commands have been sent, SCSI controller 302 will release SCSI bus 308 to allow another device to obtain control of SCSI bus 308 for other operations.

In these examples, SCSI controller 302 keeps track of SCSI peripherals with which SCSI controller 302 has negotiated a packetized SCSI protocol. Packetized SCSI protocol provides a method for transferring command and status information at the maximum data rate on a parallel SCSI bus. This protocol was first described in SPI-3 and is present in SPI-4. These standards are developed by the American National Standards Institute (ANSI) National Committee for Information Technology Standards (NCITS) T10 Technical Committee. This protocol defines parallel SCSI entities called “packets” or “SPI information packets”. In particular, the examples illustrated herein involve SPI command information units, which contain a SCSI command. The mechanism of the present invention is implemented by SCSI controller 302 in these examples and allows SCSI controller 302 to batch together messages from host device driver 300 so they may be sent to SCSI peripheral 306 using “Multiple Command”. SCSI controller 302 will batch commands with the same target ID together until a condition that stops the batching process is encountered. In these examples, SCSI controller 302 only looks to see if the next message can be batched with the current message and does not look past the next message for messages that can be batched if that next message cannot be batched.

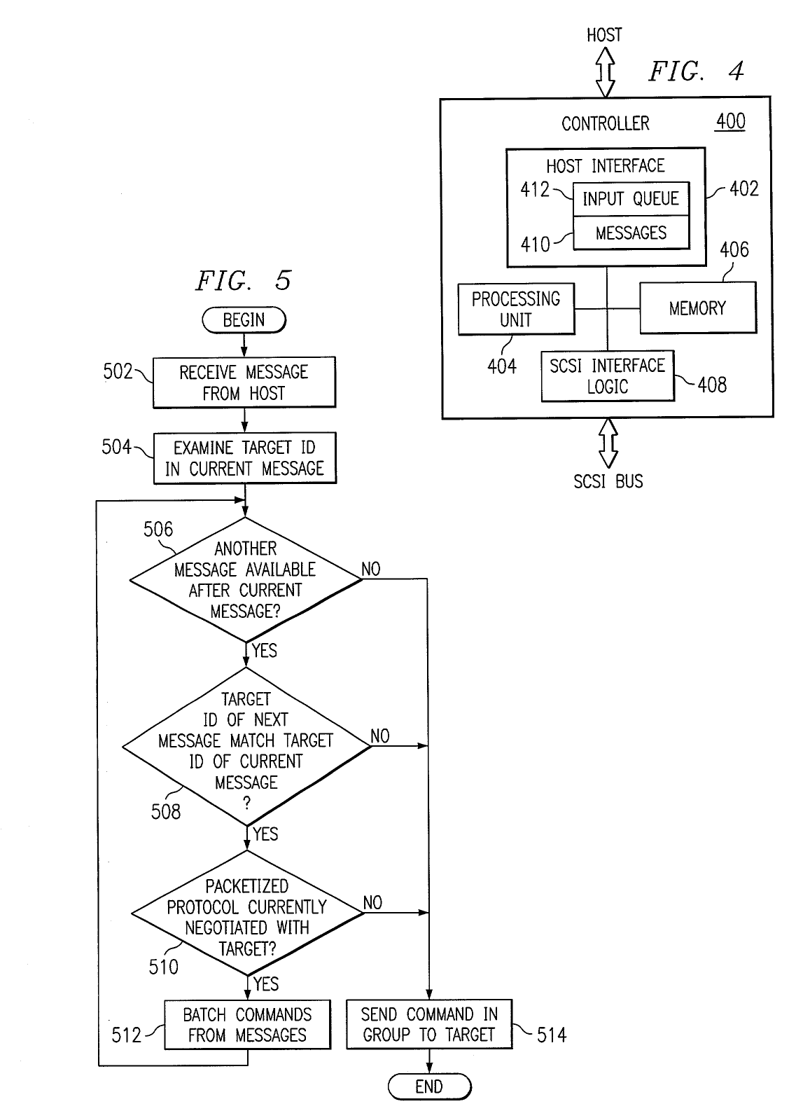

Turning now to FIG. 4, a diagram of a SCSI controller is depicted in accordance with a preferred embodiment of the present invention. SCSI controller 400 may be implemented as SCSI controller 302 in FIG. 3. SCSI controller 400 includes host interface 402, processing unit 404, memory 406, and SCSI interface logic 408. In these examples, host interface 402 provides an interface to a host device driver. Messages 410 are received by host interface 402 and stored in input queue 412. Processing unit 404 processes messages 410 and sends commands to target devices through 408. In these examples, processing unit 404 may be implemented in various ways. For example, processing unit 404 may be a processor, an advanced reduced instruction set computer machine (ARM), or an application specific integrated circuit (ASIC). Instructions or code for processing unit 404 may be stored in memory 406. Further, data or responses returned by a device also may be stored in memory 406 for return to the requestor. The process for batching commands according to the present invention may be implemented within processing unit 404.

The batching of commands using the mechanism of the present invention is initiated by using “Multiple Command”. Specifically, when a message, containing a command, is received in input queue 412, processing unit 404 will examine the target ID in this message. Further, processing unit 404 will check to see if another message is available following the message currently being processed. If another message is not present in input queue 412, then no further commands will be included in this group of batched commands. Otherwise, if another message is present, the target ID for this next message is compared with the target ID in the current message to see whether the command in the next message should be batched with the command in the current message. If the target IDs match, then these two commands may be batched into the same group. Processing unit 404 also determines, in these examples, if a packetized SCSI protocol for information unit transfers is currently negotiated with the target. If such a protocol has not been negotiated, then no further commands are included in this group of batched commands. These comparisons and groupings are performed until no further commands can be batched together. At that time, processing unit 404 sends the commands in the group to the target through SCSI interface logic 408. These commands are sent in a single connection in the order in which they were received. In this group of batched commands, all of the commands except the last command in the group are of the “Multiple Command” type. Designating a command as a “Multiple Command” indicates that additional commands will follow this command. The last command in the group is designated or sent as a command type of “Last Command” to indicate that no other commands will follow this command.

In this manner, the mechanism of the present invention allows for batching to be performed in an efficient manner. The arbitration, selection, and bus release steps are only performed once for all of these commands. Further, the mechanism of the present invention requires no changes to the host device driver or to the interface between the host device driver and the SCSI controller.

Only the components used in batching commands are illustrated in SCSI controller 400.

Those of ordinary skill in the art will realize that this controller may contain other components in addition to or in place of those illustrated in FIG. 4. For example, an output queue also may be included to return results or responses to the host device driver.

FIG. 5 is a flowchart illustrating a process for batching commands in accordance with a preferred embodiment of the present invention. The process illustrated in FIG. 5 may be implemented by a processing unit, such as processing unit 404 within SCSI controller 400, in FIG. 4.

The process begins by receiving a message from a host (step 502). In the illustrated examples, this message is received in an input queue, such as input queue 412 in FIG. 4. This message is referred to as the current message. The target ID in this current message is then examined (step 504). A determination is then made as to whether or not another message is available after the current message (step 506). If another message is available after the current message, a determination is made as to whether the target ID of the next message matches the target ID of the current message (step 508). If the target ID of the next message matches the target ID of the current message, a determination is made as to whether the packetized SCSI protocol is currently negotiated with the target (step 510). If the packetized SCSI protocol is currently negotiated with the target in step 510, the commands in the messages are batched into a group (step 512), and the operation then returns to step 506 as described above. This process is repeated to add additional commands to the group until one of the conditions in steps 506, 508, or 510 are no longer valid.

With reference again to step 510, if the packetized SCSI protocol is not currently negotiated with the target, all of the commands in the group are sent to the target (step 514) with the process terminating thereafter. With reference back to step 508, if the target ID of the next message does not match the target ID of the current message, the commands in the group also are sent to the target (step 514). In step 506, if another message is not available after the current message, the process also proceeds to step 514 as described above.

Thus, the present invention provides an improved method and apparatus for sending commands to a target device from a SCSI controller. The mechanism of the present invention defines a process in which multiple commands can be batched together, avoiding having to perform arbitration, selection, and bus release for each command. This mechanism also provides an advantage in that the mechanism avoids having to make changes to the host device driver or to the interface between the host device driver and the SCSI controller. Additionally, the mechanism of the present invention also provides an advantage in that the mechanism may be implemented solely on the SCSI controller. This mechanism requires no changes to the host device driver or to the interface between the host device driver and the SCSI controller. Thus, the mechanism of the present invention may be implemented without requiring changes to multiple components.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. In this manner, controllers may be updated to include the mechanism of the present invention through these types of computer readable media. Examples of computer readable media include recordable-type media, such as a floppy disk, a hard disk drive, a RAM, CD-ROMs, DVD-ROMs, and transmission-type media, such as digital and analog communications 10 links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. For example, the examples illustrate receiving messages in an input queue within the controller. These messages may be received and stored using some other mechanism other than an input queue depending on the particular implementation. For example, a memory array or a buffer may be used to receive these messages. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method for processing commands in a small computer system interface controller, the method comprising:
receiving a current command, wherein the current command is associated with a first target identifier;
determining whether a subsequent command is available after the current command;
determining whether the first target identifier matches a second target identifier associated with the subsequent command if the subsequent command is available; and
batching the current command with the subsequent command if the first target identifier matches the second target identifier, wherein the current command and the subsequent command are sent from the small computer system interface controller to a target using a single connection.

2. The method of claim 1 further comprising:
preventing batching of the current command with the subsequent command if an absence of a negotiation of a packetized small computer system interface protocol with the target is present.

3. The method of claim 1, wherein the current command and the subsequent command form a group and further comprising:
sending the group to a target identified by the first target identifier in one connection.

4. The method of claim 1, wherein the method is implemented in one of a processor or an application specific integrated circuit.

5. The method of claim 1, wherein the method is initiated in response to receiving a select command, selecting a device.

6. The method of claim 1, wherein the target is a hard disk drive.

7. The method of claim 1, wherein the current command and the first target identifier are received in a message from a host.

8. A method for processing commands in a small computer system interface controller, the method comprising:
receiving a current command from a host driver, wherein the current command is associated with a current target identifier for a target device;
determining whether a subsequent command is present;
responsive to the subsequent command being present, determining whether the current target identifier matches a subsequent target identifier associated with the subsequent command;
batching the current command with the subsequent command in a group if the current target identifier matches the subsequent target identifier;
sending the group to the target device using a single connection if a subsequent command is absent; and
sending the group to the target using a single connection if a match between the current target identifying and the subsequent identifier is absent.

9. The method of claim 8, wherein the batching step further includes:
batching the current command with the subsequent command in the group if a packetized small computer system interface protocol is currently negotiated with the target in addition to the current target identifier matching the subsequent target identifier.

10. The method of claim 8, wherein the current command and the subsequent command are received in a queue.

11. A controller comprising:
a host interface, wherein the controller receives messages from a host through the host interface;
a bus interface, wherein the controller sends the messages to a target through the bus interface; and
a processing unit connected to the host interface and the bus interface, wherein the processing unit executed instructions to identify reception of a current command from a host in which the current command includes a first target identifier, determine whether a subsequent command is available after the current command, determine whether the first target identifier matches a second target identifier in the subsequent command, and batch the current command with the subsequent command if the first target identifier matches the second target identifier, wherein the current command and the subsequent command are sent to the target using a single connection.

12. The controller of claim 11, wherein the bus interface is a small computer system interface.

13. The controller of claim 11, wherein the processing unit is one of a processor or an application specific integrated circuit.

14. A controller comprising:
a host interface, wherein the controller receives messages from a host through the host interface;
a bus interface, wherein the controller sends the messages to a target through the bus interface; and
a processing unit connected to the host interface and the bus interface, wherein the processing unit executed instructions to receive a current command from a host driver, wherein the current command is associated with a current target identifier for a target device; determine whether a subsequent command is present; determine whether the current target identifier matches a subsequent target identifier associated with the subsequent command in response to the subsequent command being present; batch the current command with the subsequent command in a group if the current target identifier matches the subsequent target identifier; send the group to the target device using a single connection if a subsequent command is absent; and send the group to the target using a single connection if a match between the current target identifying and the subsequent identifier is absent.

15. A controller for processing commands in a small computer system interface controller, the controller comprising:
receiving means for receiving a current command, wherein the current command is associated with a first target identifier;
first determining means for determining whether a subsequent command is available after the current command;
second determining means for determining whether the first target identifier matches a second target identifier associated with the subsequent command if the subsequent command is available; and
batching means for batching the current command with the subsequent command if the first target identifier matches the second target identifier, wherein the current command and the subsequent command are sent from the small computer system interface controller to a target using a single connection.

16. The controller of claim 15 further comprising:
preventing means for preventing batching of the current command with the subsequent command if an absence of a negotiation of a packetized small computer system interface protocol with the target is present.

17. The controller of claim 15, wherein the current command and the subsequent command form a group and further comprising:
sending means for sending the group to a target identified by the first target identifier in one connection.

18. The controller of claim 15, wherein the receiving means, first determining means, second determining means, and the batching means are implemented in one of a processor or an application specific integrated circuit.

19. The controller of claim 15, wherein the target is a hard disk drive.

20. The controller of claim 15, wherein the current command and the first target identifier are received in a message from a host.

21. A controller for processing commands in a small computer system interface controller, the controller comprising:
receiving means for receiving a current command from a host driver, wherein the current command is associated with a current target identifier for a target device;
first determining means for determining whether a subsequent command is present; second determining means, responsive to the subsequent command being present, for determining whether the current target identifier matches a subsequent target identifier associated with the subsequent command;
batching means for batching the current command with the subsequent command in a group if the current target identifier matches the subsequent target identifier; first sending means for sending the group to the target device using a single connection if a subsequent command is absent; and
second sending means for sending the group to the target using a single connection if a match between the current target identifying and the subsequent identifier is absent.

22. The controller of claim 21, wherein the batching means further includes:
batching means for batching the current command with the subsequent command in the group if a packetized small computer system interface protocol is currently negotiated with the target in addition to the current target identifier matching the subsequent target identifier.

23. The controller of claim 21, wherein the current command and the subsequent command are received in a queue.

24. A computer program product in a computer readable medium for processing commands in a small computer system interface controller, the computer program product comprising:
first instructions for receiving a current command, wherein the current command is associated with a first target identifier;
second instructions for determining whether a subsequent command is available after the current command;
third instructions for determining whether the first target identifier matches a second target identifier associated with the subsequent command if the subsequent command is available; and
fourth instructions for batching the current command with the subsequent command if the first target identifier matches the second target identifier, wherein the current command and the subsequent command are sent from the small computer system interface controller to a target using a single connection.

25. A computer program product in a computer readable medium for processing commands in a small computer system interface controller, the computer program product comprising: first instructions for receiving a current command from a host driver, wherein the current command is associated with a current target identifier for a target device;
second instructions for determining whether a subsequent command is present;
third instructions, responsive to the subsequent command being present, for determining whether the current target identifier matches a subsequent target identifier associated with the subsequent command;
fourth instructions for batching the current command with the subsequent command in a group if the current target identifier matches the subsequent target identifier;
fifth instructions for sending the group to the target device using a single connection if a subsequent command is absent; and
sixth instructions for sending the group to the target using a single connection if a match between the current target identifying and the subsequent identifier is absent.
